(19) United States
(12) Patent Application Publication
(10) Pub. No.: US 2021/0131613 A1
(43) Pub. Date: May 6, 2021

(54) Integration of Contaminant Separation and Regasification Systems

(71) Applicant: ExxonMobil Upstream Research Company, Spring, TX (US)

(72) Inventors: David W. MAHER, Spring, TX (US); Chad C. RASMUSSEN, Spring, TX (US); Richard Perry CONNELL, Houston, TX (US)

(21) Appl. No.: 17/063,030

(22) Filed: Oct. 5, 2020

Related U.S. Application Data
(60) Provisional application No. 62/927,757, filed on Oct. 30, 2019.

(51) Int. Cl. F17C 9/04; F25J 1/00

(52) U.S. Cl. CPC F17C 9/04; F25J 1/0027; F17C 2250/0647; F17C 2265/05; F17C 2223/0161; F17C 2221/033

(57) ABSTRACT

Methods and systems for cryogenically separating contaminants and regasification of LNG utilizing common refrigeration equipment and/or fuel. An integrated system includes: a component for separating contaminants from an input feed stream; a heat exchanger coupled to a first line, wherein: the first line is coupled to the component for separating contaminants, and the heat exchanger cools a first feed stream of the first line; and a LNG regasification system comprising a vaporizer, wherein: the vaporizer heats a LNG stream of the LNG regasification system, and the heat exchanger functions as the vaporizer. A process includes: separating contaminants from an input feed stream with a component for separating contaminants; cooling a first feed stream with a heat exchanger, wherein the heat exchanger is coupled to the component for separating contaminants; and heating a LNG stream with a vaporizer of a LNG regasification system, wherein the heat exchanger functions as the vaporizer.

### CROSS REFERENCE TO RELATED APPLICATIONS

This application claims the priority benefit of U.S. Provisional Patent Application No. 62/927,757, filed Oct. 30, 2019, entitled INTEGRATION OF CONTAMINANT SEPARATION AND REGASIFICATION SYSTEMS.

### BACKGROUND

### Fields of Disclosure

The disclosure relates generally to the field of hydrocarbon processing, including fluid handling and separation. More specifically, the disclosure relates to the handling and separation of fluids, with outputs including hydrocarbons in a gaseous state and/or with reduced concentrations of contaminants, such as acid gas, sour gas, and/or flue gas.

### Description of Related Art

This section is intended to introduce various aspects of the art, which may be associated with the present disclosure. This discussion is intended to provide a framework to facilitate a better understanding of particular aspects of the present disclosure. Accordingly, it should be understood that this section should be read in this light, and not necessarily as admissions of prior art.

The production of natural gas hydrocarbons, such as methane and ethane, from a reservoir oftentimes carries with it the incidental production of non-hydrocarbon gases. Such gases include contaminants, such as at least one of carbon dioxide (CO₂), hydrogen sulfide (H₂S), carbonyl sulfide, carbon disulfide and various mercaptans. When a feed stream being produced from a reservoir includes these contaminants mixed with hydrocarbons, the stream is oftentimes referred to as “sour gas.”

Many natural gas reservoirs have relatively low percentages of hydrocarbons and relatively high percentages of contaminants. Contaminants may act as a diluent and lower the heat content of hydrocarbons. Some contaminants, like sulfur-bearing compounds, are noxious and may even be lethal. Additionally, in the presence of water some contaminants can become quite corrosive.

It is desirable to remove contaminants from a stream containing hydrocarbons to produce sweet and concentrated hydrocarbons. Specifications for pipeline-quality natural gas typically call for a maximum of 2 to 4% CO₂ and ¼ grain H₂S per 100 scf (4 ppmv) or 5 mg/Nm3 H₂S. Specifications for lower temperature processes, such as natural gas liquefaction plants or nitrogen rejection units, typically specify less than 50 ppm CO₂.

The separation of contaminants from hydrocarbons is difficult, and consequently significant work has been applied to the development of hydrocarbon/contaminant separation methods. These methods can be placed into three general classes: absorption by solvents (physical, chemical, and hybrids), adsorption by solids, and distillation.

Separation by distillation of some mixtures can be relatively simple and, as such, is widely used in the natural gas industry. However, distillation of mixtures of natural gas hydrocarbons, primarily methane, and one of the most common contaminants in natural gas, carbon dioxide, can present significant difficulties. Conventional distillation principles and conventional distillation equipment are predicated on the presence of only vapor and liquid phases throughout the distillation tower. The separation of CO₂ from methane by distillation involves temperature and pressure conditions that result in solidification of CO₂ if a pipeline or better quality hydrocarbon product is desired. The implicated temperatures are cold temperatures typically referred to as cryogenic temperatures (i.e., any temperature of about −40° C. (−40° F.) and lower).

Certain cryogenic distillations can overcome the above-mentioned difficulties. These cryogenic distillations provide the appropriate mechanism to handle the formation and subsequent melting of solids during the separation of solid-forming contaminants from hydrocarbons. The formation of solid contaminants in equilibrium with vapor-liquid mixtures of hydrocarbons and contaminants at particular conditions of temperature and pressure takes place in a controlled freeze zone section of a distillation tower. A lower section of the distillation tower may also help separate the contaminants from the hydrocarbons, but the lower section is operated at a temperature and pressure that does not form solids.

In known cryogenic distillation applications using a controlled freeze zone section, a feed stream is dried and precooled to a temperature of about −51° C. (−60° F.) before introduction to the distillation tower below the controlled freeze zone section and melt tray. The vapor component of the cooled feed stream combines with the vapor rising from the stripping section of the tower and bubbles through the liquid on the melt tray. This serves several beneficial purposes, including: the rising vapor stream is cooled and a portion of the CO₂ is condensed, resulting in a cooler and cleaner gas stream entering the open portion of the controlled freeze zone spray chamber; the rising vapor stream is evenly distributed across the tower cross-section as this stream enters the controlled freeze zone spray chamber; most of the required melt tray heat input is provided via sensible heat from cooling the vapor and latent heat from condensing a portion of the CO₂ in the gas stream; and the melt tray liquid is vigorously mixed, which facilitates melting of solid CO₂ particles falling into the melt tray with the bulk liquid temperature only 2 to 3° F. above the melting point of CO₂. However, cryogenic distillation applications using a controlled freeze zone section utilize several different mechanisms to reduce temperature of various feed streams. It would be beneficial to provide more efficient cooling mechanisms.

Contamination can also be a challenge following combustion of hydrocarbons (e.g., at a power plant). The burning of hydrocarbons produces “flue gases,” which include CO₂, water vapor, sulfur dioxides, and nitrogen oxides. In a post-combustion recapture process, CO₂ is separated and captured from the flue gases that result from the combustion. Procedures to recapture CO₂ from flue gases are similar to absorption-by-solvents procedures to separate CO₂ from sour gas. For example, a “filter” may help trap the CO₂ as the CO₂ travels up a chimney or smokestack. This filter includes a solvent that absorbs CO₂. The solvent may then be heated to generate water vapor and a concentrated stream of CO₂. The concentrated stream of CO₂ may be compressed and/or the temperature of the concentrated stream of CO₂ may be decreased using a heat exchanger. At least a portion of the CO₂ condenses within the heat exchanger, yielding a solid or liquid condensed-phase CO₂ component and a light-gas component. The condensed-phase CO₂ component can then be recovered. However, recovering the CO₂ product from the flue gas using such techniques may be costly due to the high degree of compression that may be involved.

Once CO₂ has been separated from a sour gas feed or recaptured from a flue gas feed, the CO₂ may be injected into a nearby well or storage formation, and/or the CO₂ may be transported (e.g., through a pipeline) to a suitable storage site. However, the CO₂ must first be cooled and/or compressed for storage and/or transport, which requires a great deal of energy. It would be beneficial to provide more efficient CO₂ cooling and/or compression mechanisms.

Many sources of natural gas are in parts of the world that are at great distances from any commercial markets for the gas. When pipeline transportation is not feasible, produced natural gas is often processed into liquefied natural gas (which is called “LNG”) for transport to market. The natural gas is thus transported as LNG to locations where the LNG can be used for heating, power generation, or industrial use. LNG is typically stored and/or shipped at temperatures of about −162° C. (−260° F.) and at substantially atmospheric pressure. However, LNG generally cannot be utilized by consumers in the very cold, liquid form. Therefore, to be used as fuel or inserted into market pipelines, LNG must be converted back to a gaseous state for distribution to consumers. The LNG is warmed and/or vaporized in a process known as regasification. Typically, LNG regasification plants are located near sea ports, either on land or on floating vessels, to facilitate receipt of LNG from around the globe. To supply vaporized gas at pipeline temperatures and/or pressures, heat may first be added to the cryogenic LNG stream. The heat may come from a variety of sources, such as: (1) burning the regasified LNG (thus losing the market value of that portion of the gas that is consumed), (2) warm water, (3) warm air, or (4) an industrial exothermic process. It would be beneficial to integrate the regasification of LNG with one or more other industrial processes to more efficiently utilize otherwise-wasted heat energy.

### SUMMARY

Embodiments of the disclosure are directed to the integration of hydrocarbon refining processes, including liquefied natural gas (“LNG”) regasification processes with processes for separating contaminants from a sour gas and/or flue gas feed streams.

Embodiments of the disclosure are concerned with a process for cryogenically separating contaminants and the regasification of LNG, wherein the two processes utilize or are integrated around common refrigeration equipment and/or fuel gas usage.

Embodiments of the disclosure are concerned with a process for using solvents to separate contaminants and the regasification of LNG, wherein the two processes utilize or are integrated around common refrigeration equipment and/or fuel gas usage.

Embodiments of the disclosure are concerned with an integrated system, including: a component for separating contaminants from an input feed stream; a heat exchanger coupled to a first line, wherein: the first line is coupled to the component for separating contaminants, and the heat exchanger cools a first feed stream of the first line; and a LNG regasification system comprising a vaporizer, wherein: the vaporizer heats a LNG stream of the LNG regasification system, and the heat exchanger functions as the vaporizer.

Embodiments of the disclosure are concerned with a process, including: separating contaminants from an input feed stream with a component for separating contaminants; cooling a first feed stream with a heat exchanger, wherein the heat exchanger is coupled to the component for separating contaminants; and heating a LNG stream with a vaporizer of a LNG regasification system, wherein the heat exchanger functions as the vaporizer.

The foregoing has broadly outlined the features of the present disclosure in order that the detailed description that follows may be better understood. Additional features will also be described herein.

### BRIEF DESCRIPTION OF THE DRAWINGS

These and other features, aspects and advantages of the disclosure will become apparent from the following description, appending claims and the accompanying drawings, which are briefly described below.

FIG. 1 is a schematic diagram of a tower with sections within a single vessel.

FIG. 2 is a schematic diagram of a tower with sections within multiple vessels.

FIG. 3 is a schematic diagram of a tower with sections within a single vessel.

FIG. 4 is a schematic diagram of a tower with sections within multiple vessels.

FIG. 5 is a schematic diagram of an LNG regasification system.

FIG. 6 is a schematic diagram of an integrated separation and regasification system.

FIG. 7 is a schematic diagram of another integrated separation and regasification system.

FIG. 8 is a schematic diagram of yet another integrated separation and regasification system.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

As referenced in this application, the terms “stream,” “gas stream,” “vapor stream,” and “liquid stream” refer to different stages of one or more feed streams as the feed streams are processed (e.g., in a distillation tower that separates methane, the primary hydrocarbon in natural gas, from contaminants). Although the phrases “gas stream,” “vapor stream,” and “liquid stream,” may refer to situations where gas, vapor, or liquid is primarily present in the stream, respectively, there may be other phases also present within the stream. For example, a gas may also be present in a “liquid stream.” In some instances, the terms “gas stream” and “vapor stream” may be used interchangeably.

The term “natural gas” refers to a multi-component gas obtained from a crude oil well (associated gas) or from a subterranean gas-bearing formation (non-associated gas). The composition and pressure of raw natural gas can vary significantly. A typical natural gas stream contains methane (C₁ carbon content) as a significant component. Raw natural gas may also contain ethane (C₂ carbon content), higher molecular weight hydrocarbons, acid gases (such as carbon dioxide, hydrogen sulfide, carbonyl sulfide, carbon disulfide, and mercaptans), and minor amounts of contaminants such as water, nitrogen, iron sulfide, wax, and crude oil. As used herein, natural gas includes gas resulting from the regasification of a liquefied natural gas (“LNG”), which has been purified to remove contaminants, such as water, acid gases, and most of the higher molecular weight hydrocarbons.

A “heat exchanger,” as referenced herein, broadly means any device capable of transferring heat from one medium to another medium, including particularly any structure, e.g., any device, commonly referred to as a heat exchanger. Heat exchangers include “direct heat exchangers” and “indirect heat exchangers.” Thus, a heat exchanger may be a plate-and-frame, shell-and-tube, spiral, hairpin, core, core-and-kettle, double-pipe, or any other type of known heat exchanger. “Heat exchanger” may also refer to any column, tower, unit, or other arrangement adapted to allow the passage of one or more streams therethrough, and to affect direct or indirect heat exchange between one or more lines of refrigerant, and one or more feed streams.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described are considered to be within the scope of the disclosure.

The articles “the,” “a,” and “an” are not necessarily limited to mean only one, but rather are inclusive and open ended so as to include, optionally, multiple such elements.

One of the many potential advantages of the embodiments of the present disclosure is that temperature control resources may be shared by multiple processes, reducing both expense and environmental impact. Other potential advantages include one or more of the following, among others that will be apparent to the skilled artisan with the benefit of this disclosure: reduction and/or elimination of independent refrigeration equipment for a cryogenic-distillation application using a controlled freeze zone section; reduction and/or elimination of independent refrigeration equipment for solvent-absorption application; and reduction and/or elimination of independent vaporization equipment for a LNG regasification system. Embodiments of the present disclosure can thereby be useful in the recovery and/or refinement of hydrocarbons from subsurface formations.

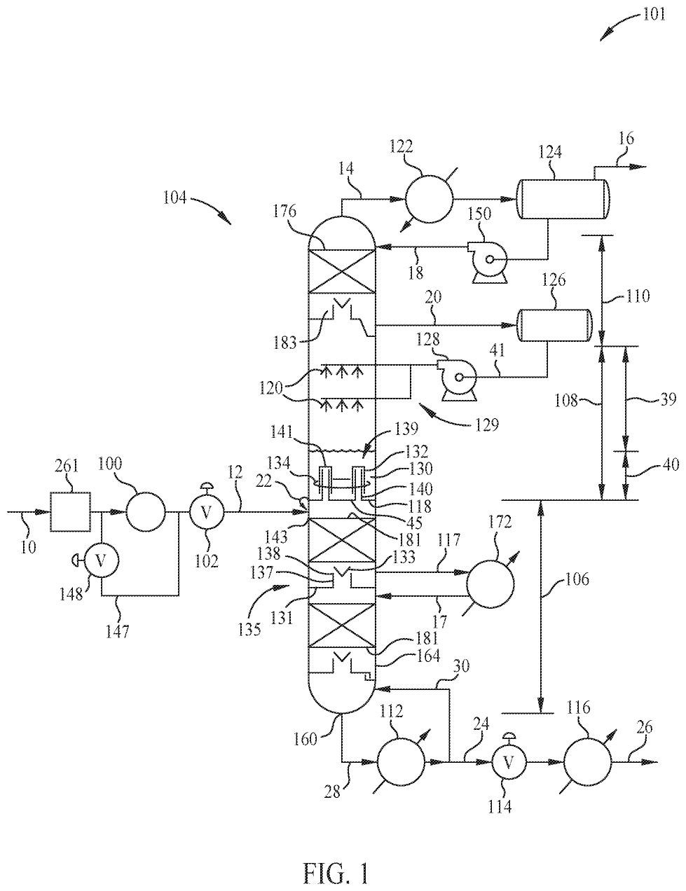

Portions of this disclosure relate to systems and methods for separating a feed stream in a distillation tower. Such systems and methods help optimally match where the feed stream enters the distillation tower based on the concentrations of components in the feed stream so as to improve energy efficiency and/or optimally size the distillation tower. The systems and methods may also help prevent the undesired accumulation of solids in the controlled freeze zone section of the distillation tower. FIGS. 1-4 of the disclosure display various aspects of such systems and methods.

Systems and methods may separate methane from contaminants in sour gas and/or flue gas feed streams (e.g., a gas having a CO₂ concentration of about 10% to about 80%).

Exemplary separation systems 101, 201, 301, 401 may comprise a distillation tower 104, 204 (FIGS. 1-4). The separation systems 101, 201, 301, 401 may prepare the feed stream (e.g., sour gas and/or flue gas feed streams), and the distillation tower 104, 204 may then separate the contaminants from the methane.

The distillation tower 104, 204 may be separated into three functional sections: a lower section 106, a middle controlled freeze zone section 108, and an upper section 110. The distillation tower 104, 204 may incorporate three functional sections when the upper section 110 is needed and/or desired.

The distillation tower 104, 204 may incorporate only two functional sections when the upper section 110 is not needed and/or desired. When the distillation tower does not include an upper section 110, a portion of vapor leaving the middle controlled freeze zone section 108 may be condensed in a condenser 122 and returned as a liquid stream via a spray assembly 129. Moreover, lines 18 and 20 may be eliminated, elements 124 and 126 may be one and the same, and elements 150 and 128 may be one and the same. The stream in line 14, now taking the vapors leaving the middle controlled freeze section 108, directs these vapors to the condenser 122.

The lower section 106 may also be referred to as a stripper section. The middle controlled freeze zone section 108 may also be referred to as a controlled freeze zone section. The upper section 110 may also be referred to as a rectifier section.

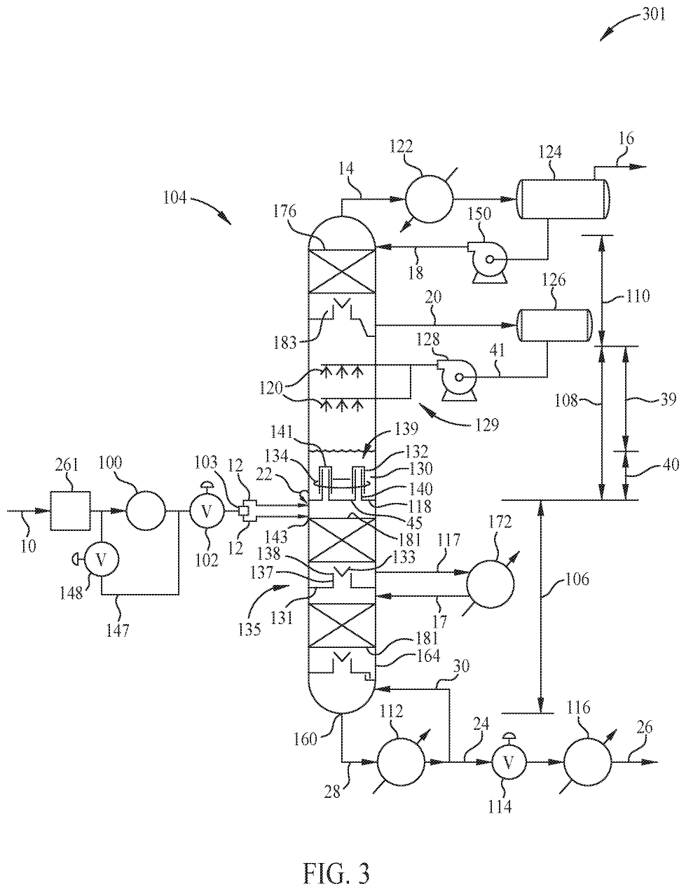

The sections of the distillation tower 104 may be housed within a single vessel (FIGS. 1 and 3). For example, the lower section 106, the middle controlled freeze zone section 108, and the upper section 110 may be housed within a single vessel 164.

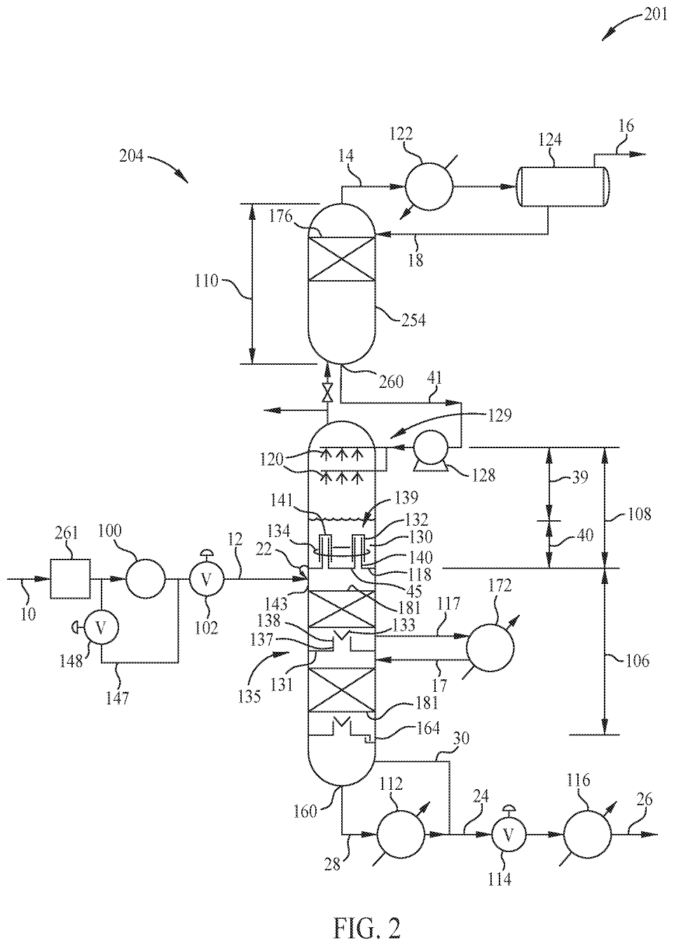

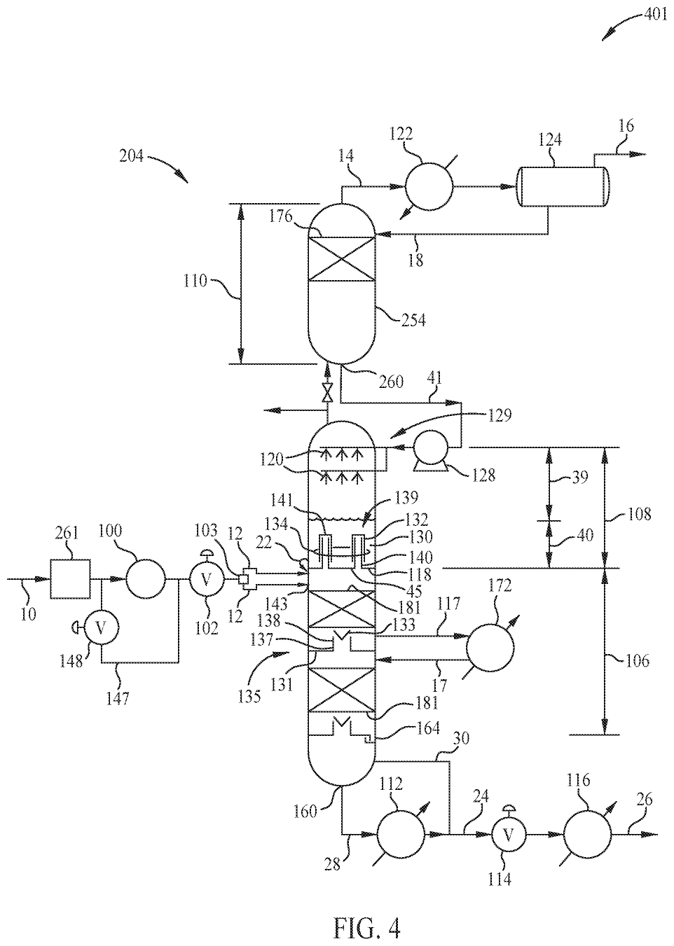

The sections of the distillation tower 204 may be housed within a plurality of vessels to form a split-tower configuration (FIGS. 2 and 4). Each of the vessels may be separate from the other vessels. Piping and/or another suitable mechanism may connect one vessel to another vessel. In this instance, the lower section 106, middle controlled freeze zone section 108, and upper section 110 may be housed within two or more vessels. For example, as shown in FIGS. 2 and 4, the upper section 110 may be housed within a single vessel 254, and the lower and middle controlled freeze zone sections 106, 108 may be housed within a single vessel 164. When this is the case, a liquid stream exiting the upper section 110 may exit through a liquid outlet bottom 260. The liquid outlet bottom 260 is at the bottom of the upper section 110. Although not shown, each of the sections may be housed within its own separate vessel, one or more section may be housed within separate vessels, or the upper and middle controlled freeze zone sections may be housed within a single vessel while the lower section may be housed within a single vessel, etc. When sections of the distillation tower are housed within vessels, the vessels may be side-by-side along a horizontal line and/or above each other along a vertical line.

The split-tower configuration may be beneficial in situations where the height of the distillation tower, motion considerations, and/or transportation issues, such as for remote locations, should be considered. This split-tower configuration allows for the independent operation of one or more sections. For example, when the upper section is housed within a single vessel and the lower and middle controlled freeze zone sections are housed within a single vessel, independent generation of reflux liquids using a substantially contaminant-free, largely hydrocarbon stream from a packed gas pipeline or an adjacent hydrocarbon line, may occur in the upper section. The reflux may be used to cool the upper section, establish an appropriate temperature profile in the upper section, and/or build up liquid inventory at the bottom of the upper section to serve as an initial source of spray liquids for the middle controlled freeze zone section. Moreover, the middle controlled freeze zone and lower sections may be independently prepared by chilling the feed stream, feeding the feed stream to the optimal location (be that in the lower section or in the middle controlled freeze zone section), generating liquids for the lower and the middle controlled freeze zone sections, and disposing the vapors off the middle controlled freeze zone section while the vapors are off specification with too high a contaminant content. Also, liquid from the upper section may be intermittently or continuously sprayed, building up liquid level in the bottom of the middle controlled freeze zone section and bringing the contaminant content in the middle controlled freeze zone section down and near steady state level so that the two vessels may be connected to send the vapor stream from the middle controlled freeze zone section to the upper section, continuously spraying liquid from the bottom of the upper section into the middle controlled freeze zone section and stabilizing operations into steady state conditions. The split tower configuration may utilize a sump of the upper section as a liquid receiver for the pump 128, therefore obviating the need for a holding vessel 126 in FIGS. 1 and 3.

The system may also include a heat exchanger 100 (FIGS. 1-4). A feed stream 10 (e.g., a sour gas feed stream, a flue gas feed stream) may enter the heat exchanger 100 before entering the distillation tower 104, 204. For example, feed stream 10 may be a feed stream from a reservoir, or feed stream 10 may be from an outlet of a gas plant. The feed stream 10 may be cooled within the heat exchanger 100. The heat exchanger 100 helps drop the temperature of the feed stream 10 to a level suitable for introduction into the distillation tower 104, 204.

The system may include an expander device 102 (FIGS. 1-4). The feed stream 10 may enter the expander device 102 before entering the distillation tower 104, 204. The feed stream 10 may be expanded, and thereby further cooled, in the expander device 102 after exiting the heat exchanger 100. The expander device 102 helps drop the temperature of the feed stream 10 to a level suitable for introduction into the distillation tower 104, 204. The expander device 102 may be any suitable device, such as a valve. If the expander device 102 is a valve, the valve may be any suitable valve that may aid in cooling the feed stream 10 before the feed stream enters the distillation tower 104, 204. For example, the valve may comprise a Joule-Thompson (J-T) valve.

The system may include a feed separator 103 (FIGS. 3-4). The feed stream may enter the feed separator before entering the distillation tower 104, 204. The feed separator may separate a feed stream having a mixed liquid and vapor stream into a liquid stream and a vapor stream. Lines 12 may extend from the feed separator to the distillation tower 104, 204. One of the lines 12 may receive the vapor stream from the feed separator. Another one of the lines 12 may receive the liquid stream from the feed separator. Each of the lines 12 may extend to the same and/or different sections (i.e., middle controlled freeze zone and lower sections) of the distillation tower 104, 204. The expander device 102 may or may not be downstream of the feed separator 103. The expander device 102 may comprise a plurality of expander devices 102 such that each line 12 has an expander device 102.

The system may include a dehydration unit 261 (FIGS. 1-4). The feed stream 10 may enter the dehydration unit 261 before entering the distillation tower 104, 204. The feed stream 10 enters the dehydration unit 261 before entering the heat exchanger 100 and/or the expander device 102. The dehydration unit 261 removes water from the feed stream 10 to prevent water from later presenting a problem in the heat exchanger 100, expander device 102, feed separator 103, or distillation tower 104, 204. The water can present a problem by forming a separate water phase (i.e., ice and/or hydrate) that plugs lines or equipment or negatively affects the distillation process. The dehydration unit 261 dehydrates the feed stream to a dew point sufficiently low to ensure a separate water phase does not form at any point downstream during the rest of the process. The dehydration unit may be any suitable dehydration mechanism, such as a molecular sieve or a glycol dehydration unit.

The system may include a filtering unit (not shown). The feed stream 10 may enter the filtering unit before entering the distillation tower 104, 204. The filtering unit may remove undesirable contaminants from the feed stream before the feed stream enters the distillation tower 104, 204. Depending on what contaminants are to be removed, the filtering unit may be before or after the dehydration unit 261 and/or before or after the heat exchanger 100.

The system may include lines 12. Each of the lines may be referred to as an inlet line 12. The feed stream is introduced into the distillation tower 104, 204 through one of the lines 12. One or more lines 12 may extend to the lower section 106 or the middle controlled freeze zone section 108 of the distillation tower 104, 204 to another of the lines 12. For example, the line 12 may extend to the lower section 106 such that the feed stream 10 may enter the lower section 106 of the distillation tower 104, 204 (FIGS. 1-4). Each line 12 may directly or indirectly extend to the lower section 106 or the middle controlled freeze zone section 108. Each line 12 may extend to an outer surface of the distillation tower 104, 204 before entering the distillation tower.

If the system includes the feed separator 103 (FIGS. 3-4), the line 12 may comprise a plurality of lines 12. Each line may be the same line as one of the lines that extends from the feed separator to a specific portion of the distillation tower 104, 204.

Before entering the distillation tower 104, 204, a sample of the feed stream 10 may enter an analyzer (not shown). The sample of the feed stream 10 may be a small sample of the feed stream 10. The feed stream 10 may comprise feed from multiple feed sources or feed from a single feed source. Each feed source may comprise, for example, a separate reservoir, one or more wellbores within one or more reservoirs, etc. The analyzer may determine the percentage of CO₂ in the sample of the feed stream 10 and, therefore, the content of CO₂ in the feed stream 10. The analyzer may connect to multiple lines 12 so that the feed stream 10 can be sent to one or more sections 106, 108 of the distillation tower 104, 204 after the sample of the feed stream 10 exits the analyzer. If the analyze determines that the percentage of CO₂ is greater than about 20% or greater than 20%, the analyzer may direct the feed stream to the line 12 extending from the lower section 106. If the analyzer determines that the percentage of CO₂ is less than about 20% or less than 20%, the analyzer may direct the feed stream to the line 12 extending from the middle controlled freeze zone section 108. The analyzer may be any suitable analyzer. For example, the analyzer may be a gas chromatograph or an infrared (IR) analyzer. The analyzer may be positioned before the feed stream 10 enters the heat exchanger 100. The feed stream 10 entering the analyzer may be a single phase.

While the feed stream 10 may be introduced into any section of the distillation tower 104, 204 regardless of the percentage of CO₂ in the feed stream 10, it is more efficient to introduce the feed stream 10 into the section of the distillation tower 104, 204 that will employ the best use of energy. For this reason, it is preferable to introduce the feed stream to the lower section 106 when the percentage of CO₂ in the feed stream is greater than any percentage about 20% or greater than 20% and to the middle controlled freeze zone section 108 when the percentage of CO₂ in the feed stream is any percentage less than about 20% or less than 20%.

The feed stream may be directly or indirectly fed to one of the sections 106, 108. Thus, for the best use of energy it may be best to introduce the feed stream into the distillation tower 104, 204 at the point in the distillation process of the distillation tower 104, 204 that matches the relevant percentage or content of CO₂ in the feed stream.

The feed stream 10 may enter a feed separator 103. The feed separator 103 separates a feed stream vapor portion from a feed stream liquid portion before the feed stream is introduced into the distillation tower 104, 204. The feed stream vapor portion may be fed to a different section or portion within a section of the distillation tower 104, 204 than the feed stream liquid portion. For example, the feed stream vapor portion may be fed to an upper controlled freeze zone section 39 of the middle controlled freeze zone section 108, and/or the feed stream liquid portion may be fed to a lower controlled freeze zone section 40 of the middle controlled freeze zone section 108 or to the lower section 106 of the distillation tower.

The lower section 106 is constructed and arranged to separate the feed stream 10 into an enriched contaminant bottom liquid stream (i.e., liquid stream) and a freezing zone vapor stream (i.e., vapor stream). The lower section 106 separates the feed stream at a temperature and pressure at which no solids form. The liquid stream may comprise a greater quantity of contaminants than of methane. The vapor stream may comprise a greater quantity of methane than of contaminants. In any case, the vapor stream is lighter than the liquid stream. As a result, the vapor stream rises from the lower section 106, and the liquid stream falls to the bottom of the lower section 106.

The lower section 106 may include and/or connect to equipment that separates the feed stream. The equipment may comprise any suitable equipment for separating methane from contaminants, such as one or more packed sections 181, or one or more distillation trays with perforations, downcomers and/or weirs (FIGS. 1-4).

The equipment may include components that apply heat to the stream to form the vapor stream and the liquid stream. For example, the equipment may comprise a first reboiler 112 that applies heat to the stream. The first reboiler 112 may be located outside of the distillation tower 104, 204. The equipment may also comprise a second reboiler 172 that applies heat to the stream. The second reboiler 172 may be located outside of the distillation tower 104, 204. Line 117 may lead from the distillation tower to the second reboiler 172. Line 17 may lead from the second reboiler 172 to the distillation tower. Additional reboilers, set up similarly to the second reboiler described above, may also be used.

The first reboiler 112 may apply heat to the liquid stream that exits the lower section 106 through a liquid outlet 160 of the lower section 106. The liquid stream may travel from the liquid outlet 160 through line 28 to reach the first reboiler 112 (FIGS. 1-4). The amount of heat applied to the liquid stream by the first reboiler 112 can be increased to separate more methane from contaminants. The more heat applied by the reboiler 112 to the stream, the more methane separated from the liquid contaminants, though more contaminants will also be vaporized.

The first reboiler 112 may apply heat to the stream within the distillation tower 104, 204. Specifically, the heat applied by the first reboiler 112 warms up the lower section 106. This heat travels up the lower section 106 and supplies heat to warm solids entering a melt tray assembly 139 (FIGS. 1-4) of the middle controlled freeze zone section 108 so that the solids form a liquid and/or slurry mix.

The second reboiler 172 applies heat to the stream within the lower section 106. This heat is applied closer to the middle controlled freeze zone section 108 than the heat applied by the first reboiler 112. As a result, the heat applied by the second reboiler 172 reaches the middle controlled freeze zone section 108 faster than the heat applied by the first reboiler 112. The second reboiler 172 also helps with energy integration.

The equipment may include one or more chimney assemblies 135 (FIGS. 1-4). While falling to the bottom of the lower section 106, the liquid stream may encounter one or more of the chimney assemblies 135.

Each chimney assembly 135 includes a chimney tray 131 that collects the liquid stream within the lower section 106. The liquid stream that collects on the chimney tray 131 may be fed to the second reboiler 172. After the liquid stream is heated in the second reboiler 172, the stream may return to the middle controlled freeze zone section 108 to supply heat to the middle controlled freeze zone section 108 and/or the melt tray assembly 139. An unvaporized stream exiting the second reboiler 172 may be fed back to the distillation tower 104, 204 below the chimney tray 131. A vapor stream exiting the second reboiler 172 may be routed under or above the chimney tray 131 when the vapor stream enters the distillation tower 104, 204.

The chimney tray 131 may include one or more chimneys 137. The chimney 137 serves as a channel that the vapor stream in the lower section 106 traverses. The vapor stream travels through an opening in the chimney tray 131 at the bottom of the chimney 137 to the top of the chimney 137. The opening is closer to the bottom of the lower section 106 than it is to the bottom of the middle controlled freeze zone section 108. The top is closer to the bottom of the middle controlled freeze zone section 108 than it is to the bottom of the lower section 106.

Each chimney 137 has an attached chimney cap 133. The chimney cap 133 covers a chimney top opening 138 of the chimney 137. The chimney cap 133 prevents the liquid stream from entering the chimney 137. The vapor stream exits the chimney assembly 135 via the chimney top opening 138.

After falling to the bottom of the lower section 106, the liquid stream exits the distillation tower 104, 204 through the liquid outlet 160. The liquid outlet 160 is within the lower section 106 (FIGS. 1-4). The liquid outlet 160 may be located at the bottom of the lower section 106.

After exiting through the liquid outlet 160, the feed stream may travel via line 28 to the first reboiler 112. The feed stream may be heated by the first reboiler 112, and vapor may then re-enter the lower section 106 through line 30. Unvaporized liquid may continue out of the distillation process via line 24.

The systems may include an expander device 114 (FIGS. 1-4). After entering line 24, the heated liquid stream may be expanded in the expander device 114. The expander device 114 may be any suitable device, such as a valve. The valve 114 may be any suitable valve, such as a J-T valve.

The system may include a heat exchanger 116 (FIGS. 1-4). The liquid stream heated by the first reboiler 112 may be cooled or heated by the heat exchanger 116. The heat exchanger 116 may be a direct heat exchanger or an indirect heat exchanger. The heat exchanger 116 may comprise any suitable heat exchanger. After exiting the heat exchanger 116, the liquid stream exits the distillation process via line 26.

The vapor stream in the lower section 106 rises from the lower section 106 to the middle controlled freeze zone section 108. The middle controlled freeze zone section 108 is constructed and arranged to separate the feed stream 10 introduced into the middle controlled freeze zone section, or into the top of lower section 106, into a solid and a vapor stream. The middle controlled freeze zone section 108 forms a solid, which may comprise more of contaminants than of methane. The vapor stream (i.e., methane-enriched vapor stream) may comprise more methane than contaminants.

The middle controlled freeze zone section 108 includes a lower section 40 and an upper section 39. The lower section 40 is below the upper section 39. The lower section 40 directly abuts the upper section 39. The lower section 40 is primarily but not exclusively a heating section of the middle controlled freeze zone section 108. The upper section 39 is primarily but not exclusively a cooling section of the middle controlled freeze zone section 108. The temperature and pressure of the upper section 39 are chosen so that the solid can form in the middle controlled freeze zone section 108.

The middle controlled freeze zone section 108 may comprise a melt tray assembly 139 that is maintained in the middle controlled freeze zone section 108 (FIGS. 1-4). The melt tray assembly 139 is within the lower section 40 of the middle controlled freeze zone section 108. The melt tray assembly 139 is not within the upper section 39 of the middle controlled freeze zone section 108.

The melt tray assembly 139 is constructed and arranged to melt solids formed in the middle controlled freeze zone section 108. When the warm vapor stream rises from the lower section 106 to the middle controlled freeze zone section 108, the vapor stream immediately encounters the melt tray assembly 139 and supplies heat to melt the solids. As shown in FIGS. 1-4, the melt tray assembly 139 may comprise at least one of a melt tray 118, a bubble cap 132, a liquid 130, one or more draw-off openings, one or more return inlets, and optionally may include a heat mechanism(s) 134.

The melt tray 118 may collect a liquid and/or slurry mix. The melt tray 118 divides at least a portion of the middle controlled freeze zone section 108 from the lower section 106. The melt tray 118 is at the bottom 45 of the middle controlled freeze zone section 108.

One or more bubble caps 132 may act as a channel for the vapor stream rising from the lower section 106 to the middle controlled freeze zone section 108. The bubble cap 132 may provide a path for the vapor stream up a riser 140 and then down and around the riser 140 to the melt tray 118. The riser 140 is covered by a cap 141. The cap 141 prevents the liquid 130 from travelling into the riser and also helps prevent solids from travelling into the riser 140. The vapor stream's traversal through the bubble cap 132 allows the vapor stream to transfer heat to the liquid 130 within the melt tray assembly 139.

One or more heat mechanisms 134 may further heat up the liquid 130 to facilitate melting of the solids into a liquid and/or slurry mix. The heat mechanism(s) 134 may be located anywhere within the melt tray assembly 139. For example, as shown in FIGS. 1-4, a heat mechanism 134 may be located around bubble caps 132. The heat mechanism 134 may be any suitable mechanism, such as a heat coil. The heat source of the heat mechanism 134 may be any suitable heat source.

The liquid 130 in the melt tray assembly is heated by the vapor stream. The liquid 130 may also be heated by the one or more heat mechanisms 134. The liquid 130 helps melt the solids formed in the middle controlled freeze zone section 108 into a liquid and/or slurry mix. Specifically, the heat transferred by the vapor stream heats up the liquid, thereby enabling the heat to melt the solids. The temperature of the liquid 130 may be at a level sufficient to melt the solids.

The heat duty cycle for heat exchanger 100 may be maximized to provide the most efficient operation. As a precaution, a feed gas bypass line 147 and a bypass valve 148 may be used to permit the feed gas 10 to bypass the heat exchanger 100, thereby increasing the temperature of the feed gas. This option may be used if feed gas risers, which introduce feed gas above the liquid level of liquid 130, experience fouling from solid CO₂ in a low CO₂ environment.

The middle controlled freeze zone section 108 may also comprise a spray assembly 129. The spray assembly 129 cools the vapor stream that rises from the lower section 40. The spray assembly 129 sprays liquid, which is cooler than the vapor stream, on the vapor stream to cool the vapor stream. The spray assembly 129 is within the upper section 39. The spray assembly 129 is not within the lower section 40. The spray assembly 129 is above the melt tray assembly 139. In other words, the melt tray assembly 139 is below the spray assembly 129.

The spray assembly 129 includes one or more spray nozzles 120 (FIGS. 1-4). Each spray nozzle 120 sprays liquid on the vapor stream. The spray assembly 129 may also include a spray pump 128 (FIGS. 1-4) that pumps the liquid. Instead of a spray pump 128, gravity may induce flow in the liquid.

The liquid sprayed by the spray assembly 129 contacts the vapor stream at a temperature and pressure at which solids form. Solids, containing mainly contaminants, form when the sprayed liquid contacts the vapor stream. The solids fall toward the melt tray assembly 139.

The temperature in the middle controlled freeze zone section 108 cools down as the vapor stream travels from the bottom of the middle controlled freeze zone section 108 to the top of the middle controlled freeze zone section 108. The methane in the vapor stream rises from the middle controlled freeze zone section 108 to the upper section 110. Some contaminants may remain in the methane and also rise. The contaminants in the vapor stream tend to condense or solidify with the colder temperatures and fall to the bottom of the middle controlled freeze zone section 108.

The solids form the liquid and/or slurry mix when in the liquid 130. The liquid and/or slurry mix flows from the middle controlled freeze zone section 108 to the lower section 106. At least part of the liquid and/or slurry mix flows from the bottom of the middle controlled freeze zone section 108 to the top of the lower section 106 via a line 22 (FIGS. 1-4). The line 22 may be an exterior line. The line 22 may extend from the distillation tower 104, 204. The line 22 may extend from the middle controlled freeze zone section 108. The line may extend to the lower section 106. The line 22 may extend from an outer surface of the distillation tower 104, 204.

As shown in FIGS. 1-4, the vapor stream that rises in the middle controlled freeze zone section 108 and does not form solids or otherwise fall to the bottom of the middle controlled freeze zone section 108, rises to the upper section 110. The upper section 110 operates at a temperature, pressure, and contaminant concentration at which no solid forms. The upper section 110 is constructed and arranged to cool the vapor stream to separate the methane from the contaminants. Reflux in the upper section 110 cools the vapor stream. The reflux is introduced into the upper section 110 via line 18. Line 18 may extend to the upper section 110. Line 18 may extend from an outer surface of the distillation tower 104, 204.

After contacting the reflux in the upper section 110, the feed stream forms a vapor stream and a liquid stream. The vapor stream mainly comprises methane. The liquid stream comprises relatively more contaminants. The vapor stream rises in the upper section 110, and the liquid falls to a bottom of the upper section 110.

To facilitate separation of the methane from the contaminants when the stream contacts the reflux, the upper section 110 may include one or more mass transfer devices 176. Each mass transfer device 176 helps separate the methane from the contaminants. Each mass transfer device 176 may comprise any suitable separation device, such as a tray with perforations, or a section of random or structured packing to facilitate contact of the vapor and liquid phases.

After rising, the vapor stream may exit the distillation tower 104, 204 through line 14. The line 14 may emanate from an upper part of the upper section 110. The line 14 may extend from an outer surface of the upper section 110. From line 14, the vapor stream may enter a condenser 122 (e.g., a heat exchanger). The condenser 122 cools the vapor stream to form a cooled stream. The condenser 122 at least partially condenses the stream. After exiting the condenser 122, the cooled stream may enter a separator 124. The separator 124 separates the vapor stream into liquid and vapor streams. The separator may be any suitable separator that can separate a stream into liquid and vapor streams, such as a reflux drum. Once separated, the vapor stream may exit the separator 124 as output product. The output product may travel through line 16 for subsequent sale to a pipeline and/or condensation to LNG. Once separated, the liquid stream may return to the upper section 110 through line 18 as the reflux. The reflux may travel to the upper section 110 via any suitable mechanism, such as a reflux pump 150 (FIGS. 1 and 3) or gravity (FIGS. 2 and 4).

The liquid stream (i.e., freezing zone liquid stream) that falls to the bottom of the upper section 110 collects at the bottom of the upper section 110. The liquid may collect on tray 183 (FIGS. 1 and 3) or at the bottommost portion of the upper section 110 (FIGS. 2 and 4). The collected liquid may exit the distillation tower 104, 204 through line 20 (FIGS. 1 and 3) or liquid outlet bottom 260 (FIGS. 2 and 4). The line 20 may emanate from the upper section 110. The line 20 may emanate from a bottom end of the upper section 110. The line 20 may extend from an outer surface of the upper section 110.

The line 20 and/or liquid outlet bottom 260 connects to a line 41. The line 41 leads to the spray assembly 129 in the middle controlled freeze zone section 108. The line 41 emanates from the holding vessel 126 (FIGS. 1 and 3). The line 41 may extend to an outer surface of the middle controlled freeze zone section 108.

The line 20 and/or liquid outlet bottom 260 may directly or indirectly (FIGS. 1-4) connect to the line 41. When the line 20 and/or liquid outlet bottom 260 directly connects to the line 41, the liquid spray may be pumped to the spray nozzle(s) 120 via any suitable mechanism, such as the spray pump 128 or gravity. When the line 20 and/or liquid outlet bottom 260 indirectly connects to the line 41, the lines 20, 41 and/or liquid outlet bottom 260 and line 41 may directly connect to a holding vessel 126 (FIGS. 1 and 3). The holding vessel 126 may house at least some of the liquid spray before the liquid is sprayed by the nozzle(s). The liquid spray may be pumped from the holding vessel 126 to the spray nozzle(s) 120 via any suitable mechanism, such as the spray pump 128 (FIGS. 1-4) or gravity. The holding vessel 126 may be needed when there is not a sufficient amount of liquid stream at the bottom of the upper section 110 to feed the spray nozzles 120.

It should be appreciated that various components of separation systems 101, 201, 301, 401 act to reduce temperatures of feed streams thereof. Such components include heat exchanger 100 and condenser 122. For example, heat exchanger 100 may drop the temperature of the feed stream 10 before feed stream 10 enters the distillation tower 104, 204. As another example, the vapor stream from line 14 may enter condenser 122, which cools the vapor stream and at least partially condenses the stream. After exiting the condenser 122, the cooled vapor stream may enter a separator 124. Each such temperature-reduction component may utilize a cooling fluid stream to provide a heat sink to reduce the temperature of the respective feed stream.

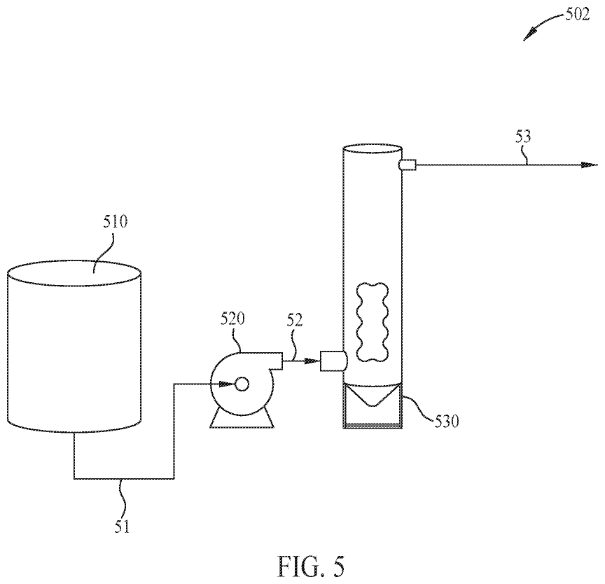

Portions of this disclosure relate to systems and methods for regasification of LNG. A simplified diagram of an LNG regasification system 502 is illustrated in FIG. 5. Generally, regasification converts LNG from liquid state to gaseous state. As illustrated, regasification system 502 includes a storage tank 510 (e.g., a tank on land, on a ship, or on a railcar), a pump 520 (e.g., a high pressure pump), and a vaporizer 530. A regasification process generally transfers liquid-state LNG from the storage tank 510 to the vaporizer 530 by action of pump 520. For example, pump 520 draws liquid-state LNG from storage tank 510 through line 51. The liquid-state LNG in line 51 may be at a temperature in a range from about −270° F. to about −250° F., or more particularly at a temperature of about −162° C. (−260° F.). Pump 520 then directs the liquid-state LNG to vaporizer 530 through line 52. At vaporizer 530, a source of heat (e.g., a heat exchanger) is used to regasify the liquid-state LNG. Vaporizer 530 converts the LNG into a gaseous state by heating at a temperature greater than about −100° C., or possibly greater than about −50° C. For example, ambient air or seawater may be utilized to heat the LNG into a gaseous state. The gaseous-state LNG (or simply “natural gas”) may be at a temperature above about −100° C., or possibly of about −45.5° C. (−50° F.). The natural gas may be delivered through line 53 to be consumed or stored.

Some embodiments provide integrated systems and methods for separating contaminants from gas feed streams (e.g., sour gas, flue gas) and for regasification of LNG. Integration may lower costs, reduce complexity, reduce geographic footprint, reduce waste, improve overall return on investment, improve scalability, and/or provide redundancy and resilience for hydrocarbon processing operations. It is currently believed that the cost of operating a cryogenic distillation tower using a controlled freeze zone section may be reduced by about 25% to about 75% by integrating the refrigeration systems with an LNG regasification system.

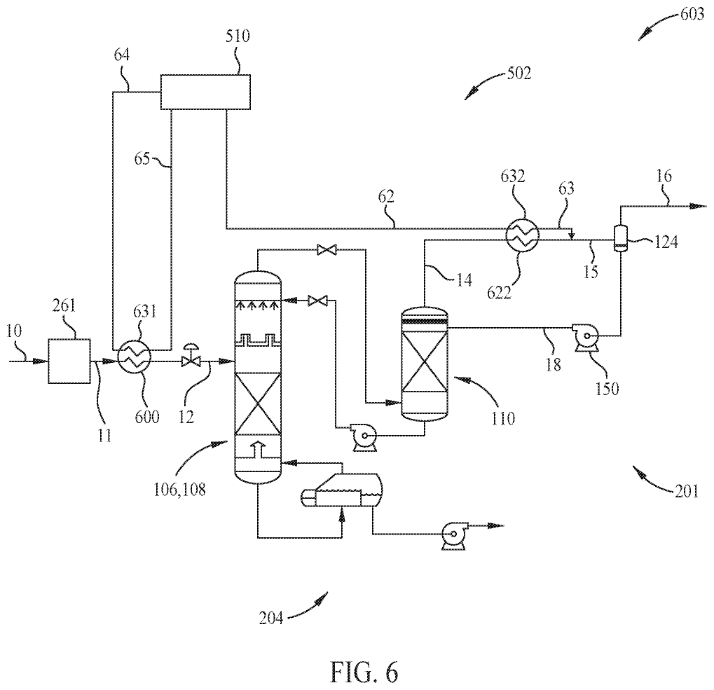

FIG. 6 illustrates an exemplary integrated separation and regasification system 603. As illustrated, system 603 generally includes components of LNG regasification system 502 and components of separation system 201. It should be appreciated that the following discussion is equally applicable to any separation system, including any of separation systems 101, 201, 301, 401. However, for simplicity, only separation system 201 will be discussed in detail. As with separation system 201, integrated system 603 may include a dehydration unit 261. A feed stream 10 (e.g., a sour gas feed stream) may enter the dehydration unit 261 before entering the heat exchanger 600 as feed stream 11. The dehydration unit 261 dehydrates the feed stream 10 to a dew point sufficiently low to ensure a separate water phase does not form at any point downstream during the rest of the process. The dehydration unit 261 may be any suitable dehydration mechanism, such as a molecular sieve or a glycol dehydration unit. In some embodiments, dehydration unit 261 may be omitted, for example, when feed stream 10 already has a sufficiently low dew point.

Similar to separation system 201, integrated system 603 may include a heat exchanger 600. The feed stream 11 may enter the heat exchanger 600 before entering the distillation tower 204. The feed stream 11 may be cooled within the heat exchanger 600 to a temperature level suitable for introduction into the distillation tower 204 (e.g., from about −62° C. to about −35° C. (from about −80° F. to about −30° F.), or more particularly about −51° C. (−60° F.)). Upon exiting the heat exchanger 600, feed stream line 12 may extend to an outer surface of the distillation tower 204 before entering the distillation tower. A cooling fluid stream for heat exchanger 600 may be provided by regasification system 502. For example, liquid-state LNG (at a temperature of from about −170° C. to about −30° C., or more particularly about −162° C.) may be delivered through line 64 to heat exchanger 600. The liquid-state LNG in line 64 from storage tank 510 may act as a cooling fluid stream for feed stream 11. Said another way, feed stream 11 may act as a heat source to help to vaporize the liquid-state LNG in line 64. Thus, the heat exchanger 600 may also function as, and/or be referred to as, a vaporizer 631. Liquid-state LNG may be partially converted at vaporizer 631 to gaseous-state LNG. In some embodiments, line 65 returns both liquid-state LNG and gaseous-state LNG to storage tank 510. In some embodiments, storage tank 510 and/or associated components thereof may utilize any gaseous-state LNG from line 65 as fuel. For example, storage tank 510 may be located on a ship, and gaseous-state LNG from line 65 may be utilized as fuel for the ship's engines. As another example, storage tank 510 may utilize associated pumps, compressors, and/or condensers, and gaseous-state LNG from line 65 may be utilized as fuel for the associated pumps, compressors, and/or condensers.

In some embodiments, liquid-state LNG in lines 64 and 65 may cool an intermediary cooling medium (e.g., ethane, propane, chlorofluorocarbon refrigerant such as R-134A), and the intermediary cooling medium may then act as the cooling fluid in heat exchanger 600. For example, the intermediary cooling medium may be contained in a closed refrigerant loop having an intermediary heat exchanger between the liquid-state LNG in lines 64 and 65 and the intermediary cooling medium. In some embodiments, the liquid-state LNG in line 64 may be pumped to a delivery pressure before being delivered to heat exchanger/vaporizer 600/631.

Similar to separation system 201, integrated system 603 may include line 14 for a vapor stream to exit the upper section 110 of the distillation tower 204. The line 14 may emanate from an upper part of the upper section 110. The line 14 may extend from an outer surface of the upper section 110. From line 14, the vapor stream may enter a heat exchanger 622. The heat exchanger 622 cools the vapor stream to form a cooled stream, exiting heat exchanger 622 through line 15. The heat exchanger 622 at least partially condenses the vapor stream. A cooling fluid stream for heat exchanger 622 may be provided by regasification system 502. For example, liquid-state LNG (at a temperature of from about −170° C. to about −30° C., or more particularly about −162° C.) may be delivered through line 62 to heat exchanger 622. The liquid-state LNG in line 62 may act as a cooling fluid stream for the vapor stream in line 14. Said another way, the vapor stream in line 14 may act as a heat source to help to vaporize the liquid-state LNG in line 62. Thus, the heat exchanger 622 may also function as, and/or be referred to as, a vaporizer 632. Liquid-state LNG may be at least partially converted at vaporizer 632 to gaseous-state LNG. In some embodiments, line 63 conveys both liquid-state LNG and gaseous-state LNG from vaporizer 632 to line 15 to combine with the cooled stream from heat exchanger 622. In some embodiments (not shown), line 63 conveys both liquid-state LNG and gaseous-state LNG from vaporizer 632 to output product in line 16 to combine with the separated vapor stream from separator 124.

The combined stream, including the cooled stream from heat exchanger 622 and the liquid-state LNG and gaseous-state LNG from vaporizer 632, may travel through line 15 to enter a separator 124. The separator 124 separates the combined stream into a liquid stream and a vapor stream. The separator may be any suitable separator that can separate a combined stream into a liquid stream and a vapor stream, such as a reflux drum. Once separated, the separated vapor stream may exit the separator 124 as output product. The output product may travel through line 16 for subsequent gaseous transport (e.g., through a pipeline) and/or condensation to LNG. Once separated, the separated liquid stream may return to the upper section 110 through line 18 as the reflux. The reflux may travel to the upper section 110 via any suitable mechanism, such as a reflux pump 150 and/or gravity. Note that the reflux of integrated system 603, unlike that of separation system 201, may include liquid that originated as LNG from storage tank 510. In some embodiments, separator 124 and/or associated components thereof may utilize any gaseous-state LNG from line 15 as fuel. For example, separator 124 may utilize associated pumps, compressors, and/or condensers, and gaseous-state LNG from line 15 may be utilized as fuel for the associated pumps (e.g., reflux pump 150), compressors, and/or condensers.

In some embodiments, output product in line 16 may contain a fractional amount of CO₂ in a specified range (e.g., about 1.5% to about 2.5%, or more particularly about 1.9% to about 2.1%). For example, heat exchanger/vaporizer 622/632 and/or separator 124 may act to create a mixture of the vapor stream in line 14 and liquid-state/gaseous-state LNG in line 63 to result in an output product in line 16 having a specified range of fractional amount of CO₂. For example, a set point and/or operating parameters of the distillation tower 204 may be specified to control separation efficiency to affect the amount of CO₂ in the vapor stream in line 14. As another example, the flowrate of the liquid-state LNG in line 62 may be controlled to affect the amount of CO₂ in the vapor stream in line 14. As another example, a slip stream of LNG may be taken off the storage tank 510, vaporized, and mixed with the output product in line 16 to dilute the CO₂ content. Any or all of these techniques may be utilized in various embodiments to affect the fractional amount of CO₂ in the output product in line 16.

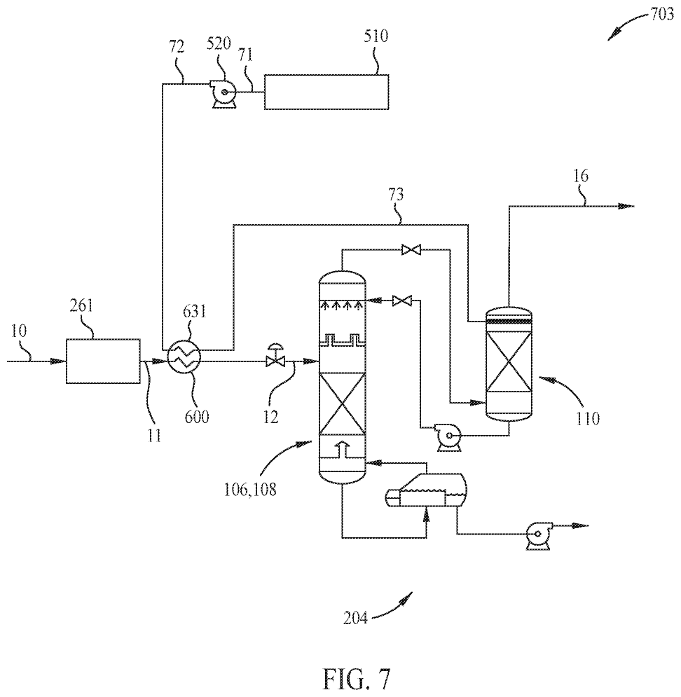

FIG. 7 illustrates another exemplary integrated separation and regasification system 703. As with integrated system 603, integrated system 703 may include a dehydration unit 261. A feed stream 10 (e.g., a sour gas feed stream) may enter the dehydration unit 261 before entering the heat exchanger 600 as feed stream 11. The dehydration unit 261 dehydrates the feed stream 10 to a dew point sufficiently low to ensure a separate water phase does not form at any point downstream during the rest of the process. The dehydration unit 261 may be any suitable dehydration mechanism, such as a molecular sieve or a glycol dehydration unit. In some embodiments, dehydration unit 261 may be omitted, for example, when feed stream 10 already has a sufficiently low dew point.

Similar to integrated system 603, integrated system 703 may include a heat exchanger 600. The feed stream 11 may enter the heat exchanger 600 before entering the distillation tower 204. The feed stream 11 may be cooled within the heat exchanger 600 to a temperature level suitable for introduction into the distillation tower 204 (e.g., from about −62° C. to about −35° C. (from about −80° F. to about −30° F.), or more particularly about −51° C. (−60° F.). Upon exiting the heat exchanger 600, feed stream line 12 may extend to an outer surface of the distillation tower 204 before entering the distillation tower. A cooling fluid stream for heat exchanger 600 may be provided by liquid-state LNG. For example, liquid-state LNG (at a temperature of from about −170° C. to about −30° C., or more particularly about −162° C.) may be delivered through line 72 from storage tank 510 to heat exchanger 600. The liquid-state LNG in line 72 may act as a cooling fluid stream for feed stream 11. Said another way, feed stream 11 may act as a heat source to help to vaporize the liquid-state LNG in line 72. Thus, the heat exchanger 600 may also function as, and/or be referred to as, a vaporizer 631. Pump 520 may draw liquid-state LNG from storage tank 510 through line 71. Pump 520 may then direct the liquid-state LNG to vaporizer 631 through line 72. Liquid-state LNG may be at least partially converted at vaporizer 631 to gaseous-state LNG. In some embodiments, line 73 conveys both liquid-state LNG and gaseous-state LNG to upper section 110 of distillation tower 204. LNG from line 73 may help cool the upper section 110 and any fluids therein. For example, LNG from line 73 may cool the vapor stream that rises in the middle controlled freeze zone section 108 and does not form solids or otherwise fall to the bottom of the middle controlled freeze zone section 108. Moreover, LNG from line 73 may cool the upper section 110 to separate methane from contaminants. In comparison to separation system 201 and/or integrated system 603, integrated system 703 may utilize only LNG from line 73 to cool upper section 110, thereby eliminating condenser 122, heat exchanger 622, separator 124, reflux pump 150, and/or any lines associated therewith. In some embodiments, distillation tower 204 and/or associated components thereof may utilize any gaseous-state LNG from line 73 as fuel. For example, distillation tower 204 may utilize associated pumps, compressors, and/or condensers, and gaseous-state LNG from line 73 may be utilized as fuel for the associated pumps, compressors, and/or condensers.

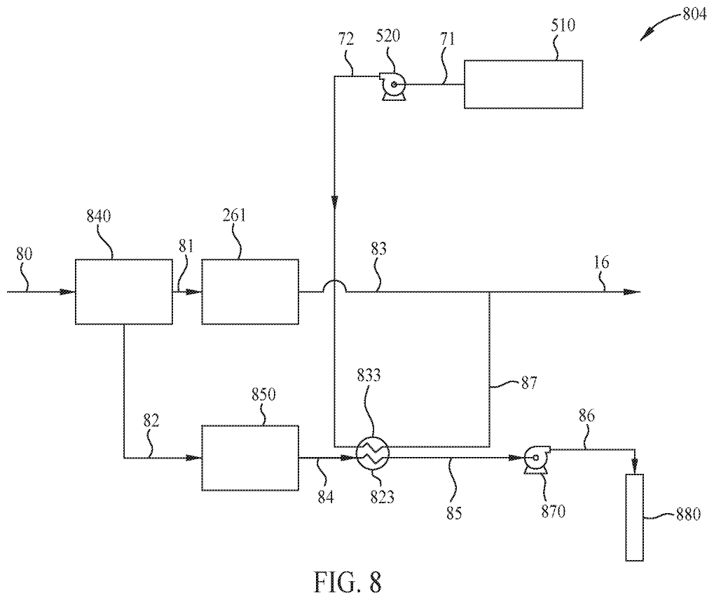

FIG. 8 illustrates another exemplary integrated separation and regasification system 804. As with integrated systems 603 and 703, integrated system 804 may both separate contaminants in a gas feed stream and regasify LNG. For integrated system 804, the input gas feed stream 80 may have a CO₂ concentration of about 2% to about 70%. For example, input gas feed stream 80 may be a flue gas (e.g., output of a power plant). As another example, input gas feed stream 80 may be an associated gas with a somewhat lower CO₂ concentration than may be applicable to input feed streams for integrated systems 603 and 703. A filter system 840 (e.g., including a membrane filter or a solvent filter) may separate feed stream 80 into a natural gas stream 81 and a CO₂-concentrated stream 82.

Natural gas stream 81 may include water vapor and hydrocarbon components (e.g., ethane, methane). A dehydration unit 261 may dehydrate the natural gas stream 81 to a dew point sufficiently low to ensure a separate water phase does not form at any point downstream. The dehydration unit 261 may be any suitable dehydration mechanism, such as a molecular sieve or a glycol dehydration unit. In some embodiments, dehydration unit 261 may be omitted, for example, when natural gas stream 81 already has a sufficiently low dew point. Dehydrated stream 83 may exit the dehydration unit 261 as output product. The output product may travel through line 16 for subsequent sale to a pipeline and/or condensation to LNG.

It is currently believed that pumping CO₂ in a liquid state may entail about 50% to about 80% less injection horsepower than pumping CO₂ in a gaseous state. Therefore, in preparation for storage and/or transport, CO₂-concentrated stream 82 may be compressed at compressor 850 to form compressed feed stream 84, and then feed stream 84 may be cooled at heat exchanger 823 to form cooled stream 85. Cooled stream 85 may include liquid-state CO₂. Heat exchanger 823 may be a condenser. Heat exchanger 823 may output cooled stream 85 at a temperature of about −57° C. (−70° F.) and a pressure of greater than about 80 psia. Liquid CO₂ pump 870 may then pump cooled stream 85 through line 86 to storage and/or transport facility 880 (e.g., an injection well).

A cooling fluid stream for heat exchanger 823 may be provided by liquid-state LNG. For example, liquid-state LNG (at a temperature of from about −170° C. to about −30° C., or more particularly about −162° C.) may be delivered through line 72 from storage tank 510 to heat exchanger 823. The liquid-state LNG in line 72 may act as a cooling fluid stream for feed stream 84. Said another way, feed stream 84 may act as a heat source to help to vaporize the liquid-state LNG in line 72. Thus, the heat exchanger 823 may also function as, and/or be referred to as, a vaporizer 833. Pump 520 may draw liquid-state LNG from storage tank 510 through line 71. Pump 520 may then direct the liquid-state LNG to vaporizer 833 through line 72. Liquid-state LNG may be at least partially converted at vaporizer 833 to gaseous-state LNG. In some embodiments, line 87 conveys both liquid-state LNG and gaseous-state LNG from vaporizer 833 to line 16 to combine with the dehydrated stream 83. The combined stream, including the dehydrated stream from dehydration unit 261 and the liquid-state LNG and gaseous-state LNG from vaporizer 833, may travel through line 16 as output product. The output product may travel through line 16 for subsequent gaseous transport (e.g., through a pipeline) and/or condensation to LNG.

In some embodiments, an integrated separation and regasification system may include a distillation tower that is collocated with a LNG regasification terminal. For example, the cold energy from vaporizing the LNG may be utilized replace refrigeration in the distillation process for separating contaminants (e.g., CO₂, H₂S) from a sour gas feed. In some embodiments, heat exchangers for vaporizing LNG may be shared as cooling components of the controlled freeze zone system. In some embodiments, all independent refrigeration and heat exchangers for the separation system may be eliminated, being replaced by shared heat exchangers. In some embodiments, the integrated system may be located onshore. For example, the integrated system may be located within about 300 km to about 500 km of a production field. As another example, the integrated system may be located within about 300 km to about 500 km of a combustion plant that emits sour gas as waste. In some embodiments, the integrated system may be deployed on an offshore floating vessel. In some embodiments, the integrated system may be configured to move between different CO₂-containing production fields.

Disclosed aspects may be used in hydrocarbon management activities. As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities. The term “hydrocarbon management” is also used for the injection or storage of hydrocarbons or CO₂, for example the sequestration of CO₂, such as reservoir evaluation, development planning, and reservoir management. The disclosed methodologies and techniques may be used to produce hydrocarbons in a feed stream extracted from, for example, a subsurface region. The feed stream extracted may be processed in the distillation tower 104, 204 and separated into hydrocarbons and contaminants. The separated hydrocarbons may exit the middle controlled freeze zone section 108 or the upper section 110 of the distillation tower. Some or all of the hydrocarbons that exit are produced. Hydrocarbon extraction may be conducted to remove the feed stream from for example, the subsurface region, which may be accomplished by drilling a well using oil well drilling equipment. The equipment and techniques used to drill a well and/or extract the hydrocarbons are well known by those skilled in the relevant art. Other hydrocarbon extraction activities and, more generally, other hydrocarbon management activities, may be performed according to known principles.

It should be understood that numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

Additionally or alternately, the invention relates to:

Embodiment 1: An integrated system, comprising: a component for separating contaminants from an input feed stream; a heat exchanger coupled to a first line, wherein: the first line is coupled to the component for separating contaminants, and the heat exchanger is configured to cool a first feed stream of the first line; and a liquefied natural gas (“LNG”) regasification system comprising a vaporizer, wherein: the vaporizer is configured to heat a LNG stream of the LNG regasification system, and the heat exchanger functions as the vaporizer.

Embodiment 2: The integrated system of Embodiment 1, wherein the component for separating contaminants comprises a cryogenic distillation tower.

Embodiment 3: The integrated system of Embodiment 2, wherein the cryogenic distillation tower comprises: a distillation section permitting vapor to rise upwardly therefrom; one or more lines for directing the input feed stream into the cryogenic distillation tower; a controlled freeze zone section situated above the distillation section, the controlled freeze zone constructed and arranged to form a solid from the input feed stream, the controlled freeze zone section including a spray assembly in an upper section of the controlled freeze zone, and a melt tray assembly in a lower section of the controlled freeze zone, wherein the melt tray assembly includes: at least one vapor stream riser that directs the vapor from the distillation section into liquid retained by the melt tray assembly, and one or more draw-off openings positioned to permit a portion of the liquid retained by the melt tray assembly to exit the controlled freeze zone section; a tower heat exchanger arranged to heat the portion of the liquid through indirect heat exchange with a heating fluid; and one or more return inlets that return the portion of the liquid to the melt tray assembly after the portion of the liquid has been heated in the tower heat exchanger.

Embodiment 4: The integrated system of any of Embodiments 1-3, wherein the contaminants comprise carbon dioxide.

Embodiment 5: The integrated system of any of Embodiments 2-4, wherein the first line directs the first feed stream from the heat exchanger to the cryogenic distillation tower.

Embodiment 6: The integrated system of any of Embodiments 2-4, wherein the first line directs the first feed stream from the cryogenic distillation tower to the heat exchanger.

Embodiment 7: The integrated system of any of Embodiments 2-6, further comprising a second heat exchanger coupled to a second line, wherein: the second line is coupled to the cryogenic distillation tower, the second heat exchanger cools a second feed stream of the second line, the LNG regasification system further comprises a second vaporizer, the second vaporizer heats a second LNG stream of the LNG regasification system, the second heat exchanger functions as the second vaporizer, the first line directs the first feed stream from the heat exchanger to the cryogenic distillation tower, and the second line directs the second feed stream from the cryogenic distillation tower to the second heat exchanger.

Embodiment 8: The integrated system of Embodiment 7, further comprising: a storage tank of the LNG regasification system; a first LNG line directing the LNG stream from the storage tank to the vaporizer; and a second LNG line directing the second LNG stream from the storage tank to the second vaporizer.

Embodiment 9: The integrated system of any of Embodiments 2-6, further comprising: a storage tank of the LNG regasification system; and a LNG line directing the LNG stream from the storage tank to the vaporizer.

Embodiment 10: The integrated system of Embodiment 9, further comprising a pump between the storage tank and the vaporizer.

Embodiment 11: The integrated system of Embodiment 9 or 10, further comprising a second LNG line directing output from the vaporizer to the storage tank.

Embodiment 12: The integrated system of Embodiment 2, further comprising: a separator, wherein: output from the vaporizer is directed to the separator, and output from the heat exchanger is directed to the separator; and a reflux pump, wherein: non-gaseous output from the separator is directed to the reflux pump, and output from the reflux pump is directed to the cryogenic distillation tower.

Embodiment 13: The integrated system of Embodiment 12, wherein gaseous output of the separator is directed to an output line as output product.

Embodiment 14: The integrated system of any of Embodiments 2-4, wherein: the first line directs the first feed stream from the heat exchanger to the cryogenic distillation tower, output from the vaporizer is directed to the cryogenic distillation tower, and gaseous output of the cryogenic distillation tower is directed to an output line as output product.

Embodiment 15: The integrated system of Embodiment 1, wherein: the component for separating contaminants comprises a filter system, the contaminants comprise carbon dioxide, the first line comprises a first carbon dioxide line, and the first feed stream comprises a first carbon dioxide stream.

Embodiment 16: The integrated system of Embodiment 15, wherein the first carbon dioxide line directs the first carbon dioxide stream from the filter system to the heat exchanger.

Embodiment 17: The integrated system of Embodiment 15, further comprising a compressor coupled to the first carbon dioxide line between the filter system and the heat exchanger.

Embodiment 18: The integrated system of any of Embodiments 15-17, further comprising: a liquid carbon dioxide pump; and a second carbon dioxide line coupling to the heat exchanger and the liquid carbon dioxide pump.

Embodiment 19: The integrated system of any of Embodiments 15-18, further comprising: a storage tank of the LNG regasification system; and a LNG line directing the LNG stream from the storage tank to the vaporizer.

Embodiment 20: The integrated system of Embodiment 19, further comprising a LNG pump between the storage tank and the vaporizer.

Embodiment 21: The integrated system of any of Embodiments 15-20, wherein gaseous output of the filter system is directed to an output line as output product.

Embodiment 22: The integrated system of Embodiment 21, further comprising a dehydration unit between the filter system and the output line.

Embodiment 23: The integrated system of Embodiment 21 or 22, wherein gaseous output of the vaporizer is directed to the output line as output product.

Embodiment 24: A method, comprising: separating contaminants from an input feed stream with a component for separating contaminants; cooling a first feed stream with a heat exchanger, wherein the heat exchanger is coupled to the component for separating contaminants; and heating a LNG stream with a vaporizer of a LNG regasification system, wherein the heat exchanger functions as the vaporizer.

Embodiment 25: The method of Embodiment 24, wherein: the separating contaminants comprises cryogenically separating contaminants, and the component for separating contaminants comprises a distillation tower.

Embodiment 26: The method of Embodiment 25, wherein cryogenically separating the contaminants comprises: directing the input feed stream into the distillation tower; permitting vapor to rise upwardly from a distillation section of the distillation tower; forming a solid in a controlled freeze zone section of the distillation tower, the controlled freeze zone section being situated above the distillation section, wherein the solid comprises contaminants in the input feed stream; directing the vapor from the distillation section into liquid retained by a melt tray assembly using at least one vapor stream riser; melting the solid using the liquid retained by the melt tray assembly; permitting a portion of the liquid retained by the melt tray assembly to exit the controlled freeze zone section; heating the portion of the liquid through indirect heat exchange with a heating fluid in a tower heat exchanger; and returning the portion of the liquid to the melt tray assembly after the liquid has been heated in the tower heat exchanger.

Embodiment 27: The method of any of Embodiments 24-26, wherein the contaminants comprise carbon dioxide.

Embodiment 28: The method of any of Embodiments 25-27, wherein the cooling the first feed stream precedes the cryogenically separating the contaminants.

Embodiment 29: The method of any of Embodiments 25-27, wherein the cryogenically separating the contaminants precedes the cooling the first feed stream.

Embodiment 30: The method of any of Embodiments 25-29, further comprising: cooling a second feed stream with a second heat exchanger; and heating a second LNG stream with a second vaporizer of the LNG regasification system, wherein: the second heat exchanger is coupled to the distillation tower, the cooling the first feed stream precedes the cryogenically separating the contaminants, the cryogenically separating the contaminants precedes the cooling the second feed stream, and the second heat exchanger functions as the second vaporizer.

Embodiment 31: The method of Embodiment 30, further comprising: directing the LNG stream from a storage tank of the LNG regasification system to the vaporizer; and directing the second LNG stream from the storage tank to the second vaporizer.

Embodiment 32: The method of any of Embodiments 25-29, further comprising directing the LNG stream from a storage tank of the LNG regasification system to the vaporizer.

Embodiment 33: The method of Embodiment 32, wherein directing the LNG stream from the storage tank to the vaporizer comprises pumping the LNG stream with a pump coupled between the storage tank and the vaporizer.

Embodiment 34: The method of Embodiment 32 or 33, further directing output from the vaporizer to the storage tank.

Embodiment 35: The method of Embodiment 25, further comprising: separating output from the vaporizer and output from the heat exchanger into an output product stream and a reflux stream; and directing the reflux stream to the cryogenic distillation tower.

Embodiment 36: The method of Embodiment 35, wherein directing the reflux stream to the cryogenic distillation tower comprises pumping the reflux stream with a reflux pump.

Embodiment 37: The method of Embodiment 35 or 36, wherein the reflux stream comprises a non-gaseous stream.

Embodiment 38: The method of any of Embodiments 35-37, wherein the output product stream comprises a fractional amount of CO₂ in a range of 1.5% to 2.5%.

Embodiment 39: The method of any of Embodiments 25-27, wherein the cooling the first feed stream precedes the cryogenically separating the contaminants; the method further comprising: directing output from the vaporizer to the cryogenic distillation tower; and generating a output product stream comprising gaseous output of the cryogenic distillation tower.

Embodiment 40: The method of Embodiment 39, wherein the output product stream comprises a fractional amount of CO₂ in a range of 1.5% to 2.5%.

Embodiment 41: The method of Embodiment 24, wherein: the contaminants comprises carbon dioxide, the component for separating contaminants comprises a filter system, and the first feed stream comprises a first carbon dioxide stream.

Embodiment 42: The method of Embodiment 41, further comprising compressing the first carbon dioxide stream.

Embodiment 43: The method of Embodiment 41 or 42, wherein the cooling the first carbon dioxide stream generates a liquid carbon dioxide stream, the method further comprising pumping the liquid carbon dioxide stream with a liquid carbon dioxide pump.

Embodiment 44: The method of any of Embodiments 41-43, further comprising directing the LNG stream from a storage tank of the LNG regasification system to the vaporizer.

Embodiment 45: The method of Embodiment 44, wherein the directing the LNG stream the storage tank to the vaporizer comprises pumping the LNG stream with a LNG pump coupled between the storage tank and the vaporizer.

Embodiment 46: The method of any of Embodiments 41-45, further comprising generating output product comprising gaseous output of the filter system.

Embodiment 47: The method of Embodiment 46, wherein generating the output product comprises dehydrating the gaseous output of the filter system.

Embodiment 48: The method of Embodiment 46 or 47, wherein the output product further comprises gaseous output of the vaporizer.

Embodiment 49: The method of any of Embodiments 46-48, wherein the output product comprises a fractional amount of CO₂ in a range of 1.5% to 2.5%.

What is claimed is:

1. An integrated system, comprising:
a component for separating contaminants from an input feed stream;
a heat exchanger coupled to a first line, wherein:
the first line is coupled to the component for separating contaminants, and
the heat exchanger is configured to cool a first feed stream of the first line; and
a liquefied natural gas (“LNG”) regasification system comprising a vaporizer, wherein:
the vaporizer is configured to heat a LNG stream of the LNG regasification system, and
the heat exchanger functions as the vaporizer.

2. The integrated system of claim 1, wherein the component for separating contaminants comprises a cryogenic distillation tower.

3. The integrated system of claim 2, wherein the cryogenic distillation tower comprises:
a distillation section permitting vapor to rise upwardly therefrom;
one or more lines for directing the input feed stream into the cryogenic distillation tower;
a controlled freeze zone section situated above the distillation section, the controlled freeze zone constructed and arranged to form a solid from the input feed stream, the controlled freeze zone section including
a spray assembly in an upper section of the controlled freeze zone, and
a melt tray assembly in a lower section of the controlled freeze zone, wherein the melt tray assembly includes:
at least one vapor stream riser that directs the vapor from the distillation section into liquid retained by the melt tray assembly, and
one or more draw-off openings positioned to permit a portion of the liquid retained by the melt tray assembly to exit the controlled freeze zone section;
a tower heat exchanger arranged to heat the portion of the liquid through indirect heat exchange with a heating fluid; and
one or more return inlets that return the portion of the liquid to the melt tray assembly after the portion of the liquid has been heated in the tower heat exchanger.

4. The integrated system of claim 2, wherein the contaminants comprise carbon dioxide.

5. The integrated system of claim 2, wherein the first line directs the first feed stream from the heat exchanger to the cryogenic distillation tower.

6. The integrated system of claim 2, wherein the first line directs the first feed stream from the cryogenic distillation tower to the heat exchanger.

7. The integrated system of claim 2, further comprising a second heat exchanger coupled to a second line, wherein:
the second line is coupled to the cryogenic distillation tower,
the second heat exchanger cools a second feed stream of the second line,
the LNG regasification system further comprises a second vaporizer,
the second vaporizer heats a second LNG stream of the LNG regasification system,
the second heat exchanger functions as the second vaporizer,
the first line directs the first feed stream from the heat exchanger to the cryogenic distillation tower, and
the second line directs the second feed stream from the cryogenic distillation tower to the second heat exchanger.

8. The integrated system of claim 7, further comprising:
a storage tank of the LNG regasification system;
a first LNG line directing the LNG stream from the storage tank to the vaporizer; and
a second LNG line directing the second LNG stream from the storage tank to the second vaporizer.

9. The integrated system of claim 2, further comprising:
a storage tank of the LNG regasification system; and
a LNG line directing the LNG stream from the storage tank to the vaporizer.

10. The integrated system of claim 9, further comprising a pump between the storage tank and the vaporizer.

11. The integrated system of claim 9, further comprising a second LNG line directing output from the vaporizer to the storage tank.

12. The integrated system of claim 2, further comprising:
a separator, wherein:
output from the vaporizer is directed to the separator, and
output from the heat exchanger is directed to the separator; and
a reflux pump, wherein:
non-gaseous output from the separator is directed to the reflux pump, and
output from the reflux pump is directed to the cryogenic distillation tower.

13. The integrated system of claim 12, wherein gaseous output of the separator is directed to an output line as output product.

14. The integrated system of claim 2, wherein:
the first line directs the first feed stream from the heat exchanger to the cryogenic distillation tower,
output from the vaporizer is directed to the cryogenic distillation tower, and
gaseous output of the cryogenic distillation tower is directed to an output line as output product.

15. The integrated system of claim 1, wherein:
the component for separating contaminants comprises a filter system,
the contaminants comprise carbon dioxide,
the first line comprises a first carbon dioxide line, and
the first feed stream comprises a first carbon dioxide stream.

16. The integrated system of claim 15, wherein the first carbon dioxide line directs the first carbon dioxide stream from the filter system to the heat exchanger.

17. The integrated system of claim 15, further comprising a compressor coupled to the first carbon dioxide line between the filter system and the heat exchanger.

18. The integrated system of claim 15, further comprising:
a liquid carbon dioxide pump; and
a second carbon dioxide line coupling to the heat exchanger and the liquid carbon dioxide pump.

19. The integrated system of claim 15, further comprising:
a storage tank of the LNG regasification system; and
a LNG line directing the LNG stream from the storage tank to the vaporizer.

20. The integrated system of claim 19, further comprising a LNG pump between the storage tank and the vaporizer.

21. The integrated system of claim 15, wherein gaseous output of the filter system is directed to an output line as output product.

22. The integrated system of claim 21, further comprising a dehydration unit between the filter system and the output line.

23. The integrated system of claim 21, wherein gaseous output of the vaporizer is directed to the output line as output product.

24. A method, comprising:
separating contaminants from an input feed stream with a component for separating contaminants;
cooling a first feed stream with a heat exchanger, wherein the heat exchanger is coupled to the component for separating contaminants; and
heating a LNG stream with a vaporizer of a LNG regasification system, wherein the heat exchanger functions as the vaporizer.

25. The method of claim 24, wherein:
the separating contaminants comprises cryogenically separating contaminants, and
the component for separating contaminants comprises a distillation tower.
